(19) United States
(12) Patent Application Publication
(10) Pub. No.: US 2009/0051172 A1
(43) Pub. Date: Feb. 26, 2009

(54) Latch assembly of fire door lock

(75) Inventors: Rick Yu, Changhua County (TW); Fu-Sheng Chen, Changhua County (TW)

Correspondence Address: BACON & THOMAS, PLLC, 625 SLATERS LANE, FOURTH FLOOR, ALEXANDRIA, VA, 22314-1176, US

(73) Assignee: Taiwan Fu Hsing Industrial Co., Ltd., Kaohsiung County (TW)

(21) Appl. No.: 12/216,644

(22) Filed: Jul. 9, 2008

(30) Foreign Application Priority Data
Aug. 23, 2007 (TW) 096131315

(51) Int. Cl. E05C 3/12

(52) U.S. Cl. 292/198

(57) ABSTRACT

A latch assembly of fire door lock comprises a latch base with a bottom, a latch bolt, a stopper, a resilient member and a linked unit. The latch bolt is retractably pivoted within the latch base and having a blocked surface. The stopper is swayingly pivoted within the latch base and having a blocked protrusion. The resilient member is disposed between the bottom of the latch base and the stopper and contacts against the stopper. The blocked protrusion of the stopper is capable of engaging with the blocked surface of the latch bolt. The linked unit is disposed within the latch base and pivotally connected with the latch bolt.

### FIELD OF THE INVENTION

The present invention is generally relating to a latch, more particularly to a latch assembly of fire door lock, which applies a stopper for controlling retraction of latch bolt and has self-locking function against high temperature.

### BACKGROUND OF THE INVENTION

In general, vertical latch of known fire door lock is pivotally mounted vertically on fire door and can be latch-released via an operation of main lock body. For example, R.O.C. Patent No. 149,199 entitled “Vertical-type latch structure of fire door lock” is disclosed, which is to release latched state via impelling a plate to drive a vertical driving sheet allowing an engaging member to retract into cylinder body. However, it needs relatively large force that the vertical latch mentioned above applies the vertical driving sheet to drive the engaging member so unable to quickly release latched state for emergency. In addition, when a fire is going for the fire door, the vertical latch mentioned above is subject to failure due to high temperature of fire, which makes the fire door become unlatched state unable to block spread of fire.

### SUMMARY

A primary object of the present invention is to provide a latch assembly of fire door lock comprising a latch base with a bottom, a latch bolt, a stopper, a resilient member and a linked unit. The latch bolt having a blocked surface is retractably pivoted within the latch base. The stopper that is swayingly pivoted within the latch base has a blocked protrusion capable of engaging with the blocked surface of the latch bolt. The resilient member is disposed between the bottom of the latch base and the stopper and contacts against the stopper. The linked unit is disposed within the latch base and pivotally connected with the latch bolt. When a fire door is opened via main lock body of a fire door lock, a connection rod is driven to move upward and further drives the linked unit to pull the latch bolt downward into the latch base for releasing latched state. Accordingly, the present invention can widely reduce latch-releasing force of the latch assembly for rapid latch-releasing movement.

A secondary object of the present invention is to provide a latch assembly of fire door lock further comprising a self-locking member and at least one hot-melt member. The hot-melt member is applied for limiting the self-locking member. When the hot-melt member melts due to high temperature of fire, the self-locking member will act to enable the latch bolt not to retract into the latch base to release latched state, so the self-locking member can allow the latch bolt to retain a latched state all the time as to effectively prevent fire door from being opened and block spread of fire.

### DESCRIPTION OF THE DRAWINGS

FIG. 1 is a perspective exploded view illustrating a latch assembly of fire door lock in accordance with a first preferred embodiment of the present invention.

FIG. 2 is a perspective assembly view illustrating the latch assembly of fire door lock in accordance with the first preferred embodiment of the present invention.

FIG. 3A-3C is an action view illustrating the latch assembly of fire door lock in accordance with the first preferred embodiment of the present invention.

FIG. 4 is a disposition view of a hot-melt member in accordance with an embodiment of the present invention.

FIG. 5A-5B is an action view of self-locking member and hot-melt member in accordance with the first preferred embodiment of the present invention.

FIG. 6 is a perspective exploded view illustrating a latch assembly of fire door lock in accordance with a second preferred embodiment of the present invention.

FIG. 7 is a perspective assembly view illustrating the latch assembly of fire door lock in accordance with the second preferred embodiment of the present invention.

FIG. 8 is a view illustrating a latch assembly in which latch bolt has step portion in accordance with another embodiment of the present invention.

FIG. 9 is a sectional view illustrating the latch assembly of fire door lock in accordance with the second preferred embodiment of the present invention.

FIG. 10 is a disposition view of a hot-melt member in accordance with one more embodiment of the present invention.

FIG. 11 is a view illustrating a latch assembly in which a stopper engages with step portion in accordance with further one more embodiment of the present invention.

FIG. 12A-12B is an action view of self-locking member and hot-melt member in accordance with the second preferred embodiment of the present invention.

### DETAILED DESCRIPTION OF THE INVENTION

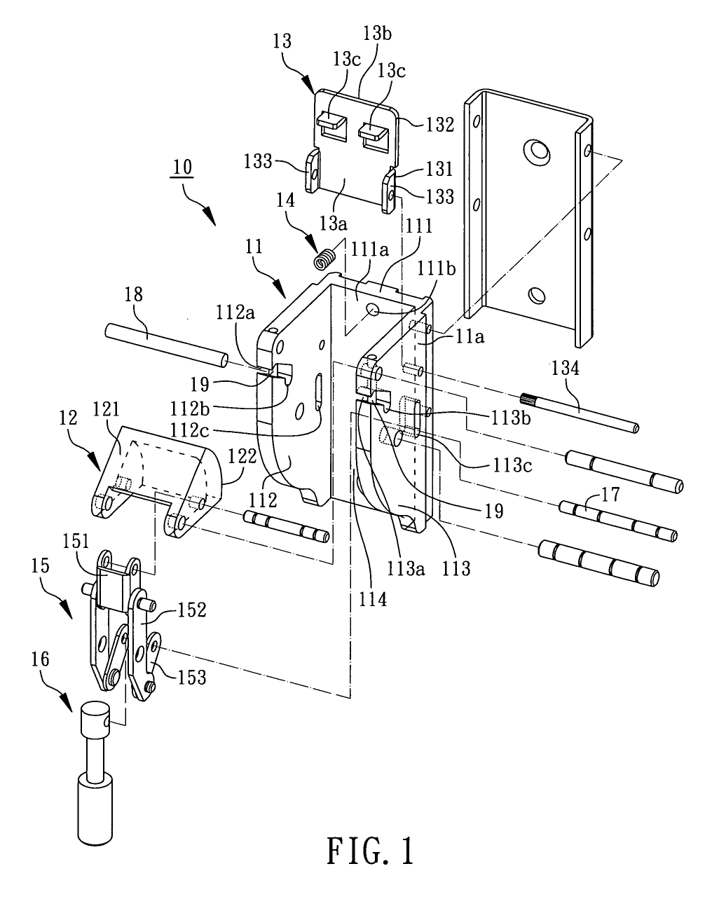

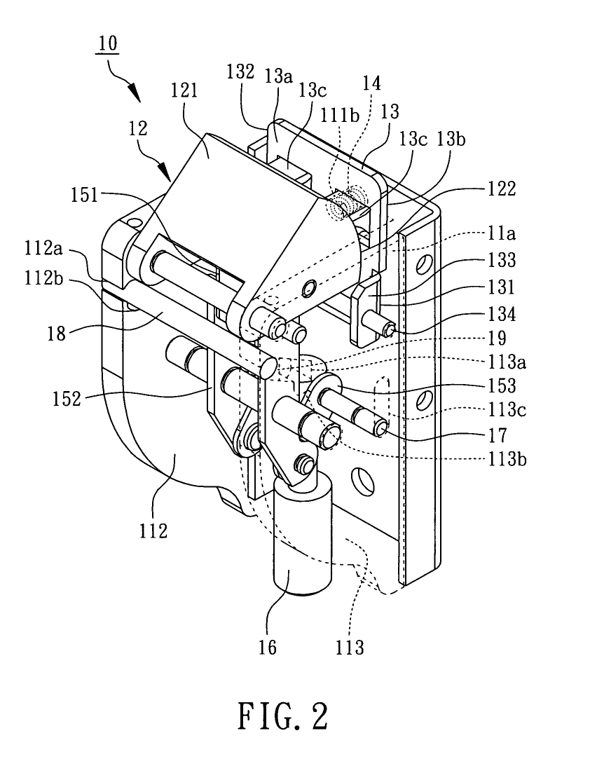

With reference to FIGS. 1 and 2, a latch assembly 10 of fire door lock in accordance with a first preferred embodiment of the present invention comprises a latch base 11, a latch bolt 12, a stopper 13, a resilient member 14, a linked unit 15 and a connection rod 16. The latch base 11 has a top 11a, a bottom 111, a first lateral 112, a second lateral 113 opposite to the first lateral 112 and a space 114 formed among the first lateral 112, the second lateral 113 and the bottom 111. The bottom 111 has an inside wall 111a and a trench 111b recessing from the inside wall 111a. The first lateral 112 and the second lateral 113 have a bias runner 112a, 113a formed thereon respectively and the bias runners 112a, 113a that are corresponding to each other communicate with the space 114 and have a position hole 112b, 113b respectively. Also, the first lateral 112 and the second lateral 113 have a longitudinal runner 112c, 113c formed thereon respectively and the longitudinal runners 112c, 113c are corresponding to each other and communicate with the space 114. The latch bolt 12 is retractably pivoted within the latch base 11 and has a blocked surface 121 and an arc surface 122 adjacent to the blocked surface 121 in this embodiment. The stopper 13 is swayingly pivoted within the latch base 11 and has a first surface 13a, a second surface 13b opposite to the first surface 13a, a first end 131 swayingly pivoted within the latch base 11, a second end 132 opposite to the first end 131 and a blocked protrusion 13c formed between the first end 131 and the second end 132. The stopper 13 has at least one fixing portion 133 formed at the first end 131 in this embodiment, preferably, the stopper 13 has two fixing portions 133 projecting from the first surface 13a respectively. Besides, the fixing portion 133 of the stopper 13 is fixed at the latch base 11 by means of a fixing pin 134 is installed penetrating the fixing portion 133 to allow the first end 131 to be swayingly pivoted within the latch base 11. The second end 132 projects from the top 11a of the latch base 11, the blocked protrusion 13c of the stopper 13 presses the arc surface 122 of the latch bolt 12, in this embodiment, the blocked protrusion 13c projects from the first surface 13a but preferably without projecting from the top 11a of the latch base 11.

With reference to FIGS. 1, 2 and 3A, the resilient member 14, disposed between the bottom 111 of the latch base 11 and the stopper 13, contacts against the second surface 13b of the stopper 13 and is a compressible spring in this embodiment. One end of the resilient member 14 can be disposed within the trench 111b of the bottom 111 of the latch base 11 and another end contacts against the stopper 13. The linked unit 15 is disposed within the latch base 11 and pivotally connected with the latch bolt 12, which comprises an upper rod 151 pivotally connected with the latch bolt 12, a lower rod 153 and a middle rod 152 pivotally connected with the upper rod 151 and the lower rod 153. Two ends of the connection rod 16 are connected with the lower rod 153 of the linked unit 15 and a main lock body (not shown in the drawings) of fire door lock respectively. In this embodiment, the latch assembly 10 further comprise a joint pin 17 slideably disposed into the longitudinal runners 112c, 113c of the first lateral 112 and the second lateral 113 and connecting the lower rod 153 of the linked unit 15 and the connection rod 16.

With reference again to FIGS. 1, 2 and 3A, the latch assembly 10 further comprises a self-locking member 18 and a pair of hot-melt members 19 in order to farther enhance fire ability. The self-locking member 18 is disposed into the bias runners 112a, 113a of the first lateral 112 and the second lateral 113. The hot-melt members 19 are fixed at the bias runner 112a of the first lateral 112 and the bias runner 113a of the second lateral 113 respectively and each of them blocks the self-locking member 18 as to prevent the self-locking member 18 from downward sliding to each of the position holes 112b, 113b. In this embodiment, each of the hot-melt members 19 has a melting temperature and will melt when heated to reach the melting temperature. Otherwise, with reference to FIG. 4, the latch assembly 10 in another embodiment may also apply only one hot-melt member 19 which is inserted into and fixed at the bias runners 112a, 113a of the first and second laterals 112, 113 and capable of blocking the self-locking member 18.

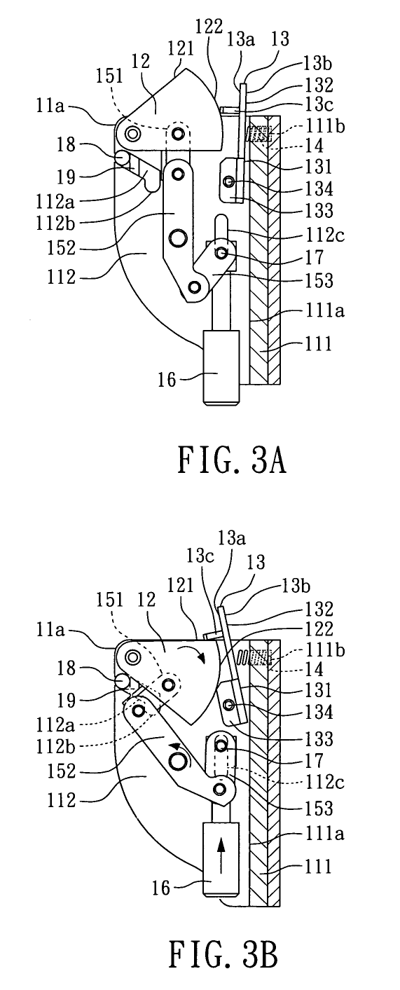

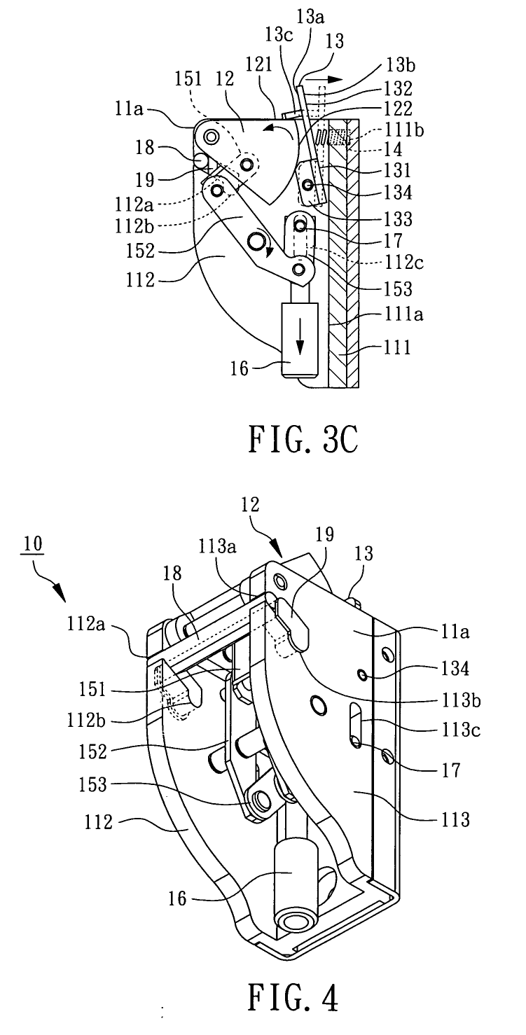

Operation of the latch assembly 10 of fire door lock will be described in detail below by referring to FIG. 3A-3C. Initially, with reference to FIGS. 2 and 3A, which illustrate disposition of each parts of the latch assembly 10 in latched state, the latch bolt 12 projects from the top 11a of the latch base 11 and the resilient member 14 contacts against the second surface 13b of the stopper 13 to allow the blocked protrusion 13c of the stopper 13 to press the arc surface 122 of the latch bolt 12. With reference to FIG. 3B, when a fire door is opened via the main lock body (not shown in the drawings) of fire door lock, the connection rod 16 is driven to move upward and meantime drives the lower rod 153 to move upward that makes the middle rod 152 rotate in counterclockwise to drive the upper rod 151 to pull the latch bolt 12 downward, so that the latch bolt 12 retracts into the latch base 11 to release latched state. In order to keep retaining unlatched state after opening the fire door, the resilient member 14 contacts against the stopper 13 to make the blocked protrusion 13c of the stopper 13 engage with the blocked surface 121 of the latch bolt 12 capable of limiting the latch bolt 12 within the latch base 11. With reference to FIG. 3C, when the fire door is closed, the stopper 13 is pushed toward the bottom 111 of the latch base 11 and presses the resilient member 14 that makes the blocked surface 121 of the latch bolt 12 depart from the limitation of the blocked protrusion 13c of the stopper 13. Meantime, the latch bolt 12 will restore to project from the top 11a of the latch base 11 to back to latched state.

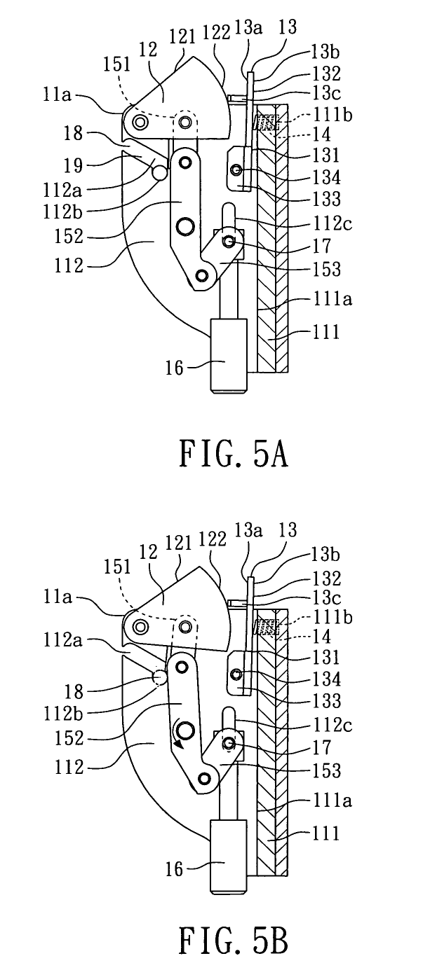

In addition, operation of the self-locking member 18 and each of the hot-melt members 19 will be described in detail below by referring to FIG. 5A-5B. First, with reference to FIGS. 1 and 5A, when fire is going for the fire door, the temperature of latch assembly 10 of the fire door lock will rise and when reaching the melting temperature, each of the hot-melt members 19 will melt. Meantime, the self-locking member 18, which is disposed into the bias runners 112a, 113a of the first lateral 112 and the second lateral 113, will slide to each of the position holes 112b, 113b. With reference to FIGS. 1 and 5B, when the self-locking member 18 slides to each of the position holes 112b, 113b, it can block the middle rod 152 of the linked unit 15 to prevent the middle rod 152 from rotating in counterclockwise and enable the latch bolt 12 not to retract into the latch base 11 to release latched state. Accordingly, the fire ability of the latch assembly 10 of fire door lock is widely improved capable of preventing the fire door from being opened and blocking spread of fire.

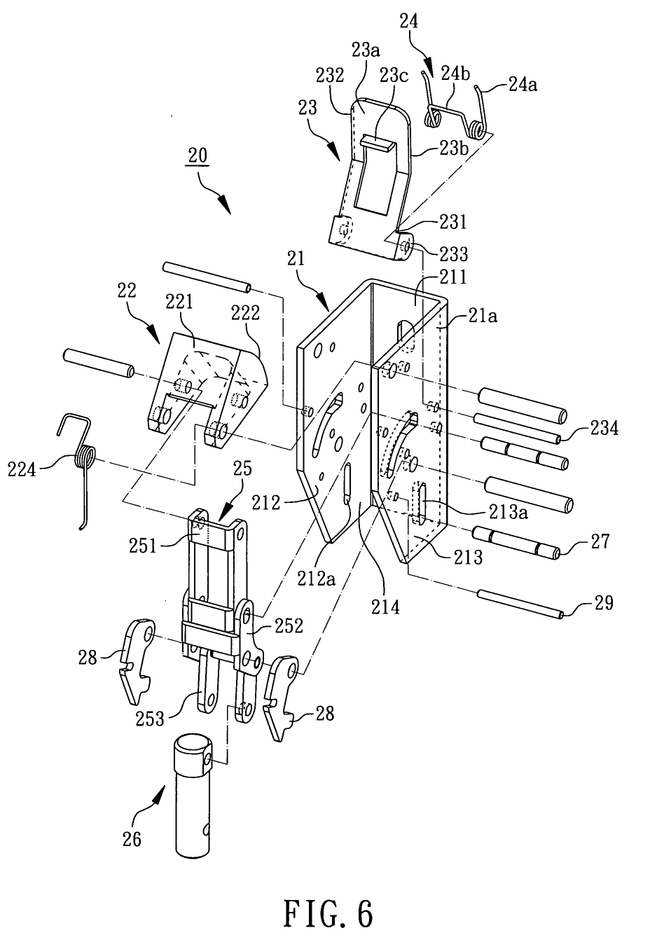

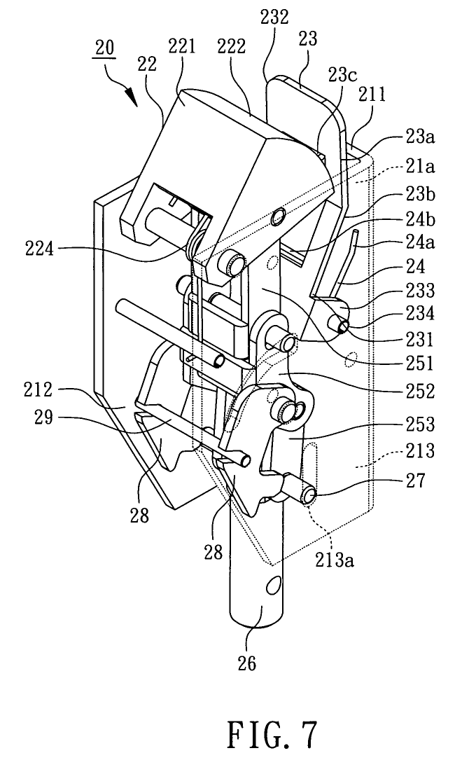

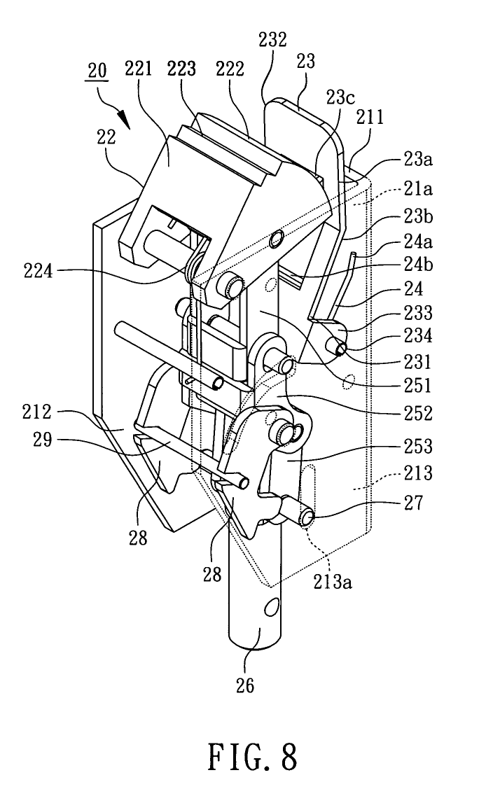

With reference to FIGS. 6 and 7, a latch assembly 20 of fire door lock in accordance with a second preferred embodiment of the present invention comprises a latch base 21, a latch bolt 22, a stopper 23, a resilient member 24, a linked unit 25 and a connection rod 26. The latch base 21 has a top 21a, a bottom 211, a first lateral 212, a second lateral 213 opposite to the first lateral 212 and a space 214 formed among the first lateral 212, the second lateral 213 and the bottom 211. The first and the second laterals 212, 213 have a longitudinal runner 212a, 213a formed thereon respectively and the longitudinal runners 212a, 213a are corresponding to each other and communicate with the space 214. The latch bolt 22 is retractably pivoted at the top 21a of the latch base 21 and has a blocked surface 221 and an arc surface 222 adjacent to the blocked surface 221 in this embodiment. Otherwise, with reference to FIG. 8, the latch bolt 22 in accordance with another embodiment may further has a step portion 223 formed at the blocked surface 221 but adjacent to the arc surface 222. With reference again to FIGS. 6 and 7, the stopper 23 has a first surface 23a, a second surface 23b opposite to the first surface 23a, a first end 231 swayingly pivoted within the latch base 21, a second end 232 opposite to the first end 231 and a blocked protrusion 23c formed between the first end 231 and the second end 232. The stopper 23 has at least one fixing portion 233 formed at the first end 231 in this embodiment, preferably, the stopper 23 has two fixing portions 233 projecting from the second surface 23b respectively. Besides, the fixing portion 233 of the stopper 23 is fixed at the latch base 21 by means of a fixing pin 234 is installed penetrating the fixing portion 233 to allow the first end 231 to be swayingly pivoted within the latch base 21. The second end 232 projects from the top 21a of the latch base 21, the blocked protrusion 23c presses the arc surface 222 of the latch bolt 22, in this embodiment, the blocked protrusion 23c projects from the first surface 23a but preferably without projecting from the top 21a of the latch base 21. In addition, the latch assembly 20 further comprises a restoration spring 224 pivotally disposed at one end of the latch bolt 22 and one end of the restoration spring 224 contacts against the latch bolt 22.

With reference to FIGS. 6, 7 and 9, the resilient member 24 is disposed between the bottom 211 of the latch base 21 and the stopper 23 and pushes the second surface 23b of the stopper 23. In this embodiment, the resilient member 24 is a torsion spring and has a contact end 24a pressing at the bottom 211 of the latch base 21 and a support end 24b contacting against the second surface 23b of the stopper 23. Otherwise, the contact end 24a can be fixed at the bottom 211 of the latch base 21 in another embodiment. With reference again to FIGS. 6, 7 and 9, the linked unit 25 is pivotally connected with the latch bolt 22 and comprises an upper rod 251 pivotally connected with the latch bolt 22, a lower rod 253 and a middle rod 252 pivotally connected with the upper rod 251 and the lower rod 253. Two ends of the connection rod 26 are connected with the lower rod 253 of the linked unit 25 and a main lock body (not shown in the drawings) of fire door lock respectively, wherein the main lock body of fire door lock drives the connection rod 26. In this embodiment, the latch assembly 20 may further comprise a joint pin 27 slideably disposed into the longitudinal runners 212a, 213a of the first lateral 212 and the second lateral 213 and connecting the lower rod 253 of the linked unit 25 and the connection rod 26.

With reference again to FIGS. 6, 7 and 9, the latch assembly 20 may further comprise a self-locking member 28 and a hot-melt member 29 in order to farther enhance fire ability. The self-locking member 28 is pivotally disposed at one side of the middle rod 252 of the linked unit 25 and has a limit end 28a. The hot-melt member 29 having a melting temperature is inserted into and fixed at the latch base 21 and penetrates the self-locking member 28 to limit the self-locking member 28 not to rotate in this embodiment. Otherwise, with reference to FIG. 10, the hot-melt member 29 is directly disposed at the limit end 28a without penetrating the self-locking member 28 in another embodiment to limit the self-locking member 28 not to rotate because the limit end 28a contacts against the hot-melt member 29.

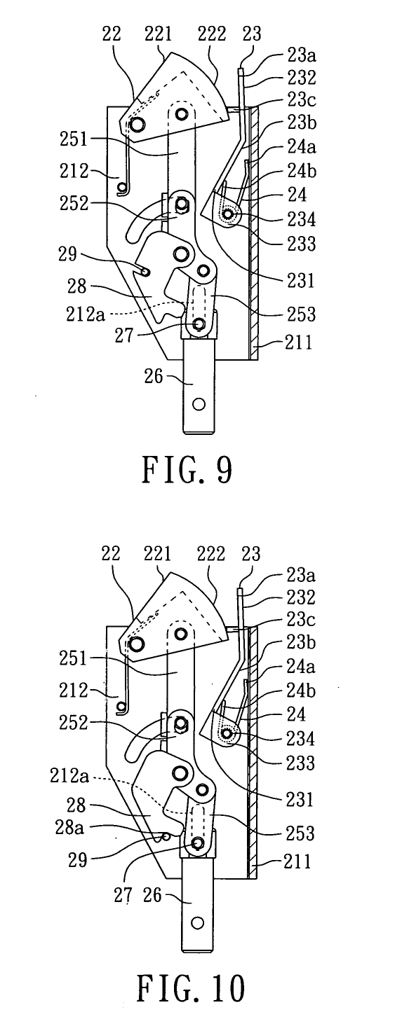

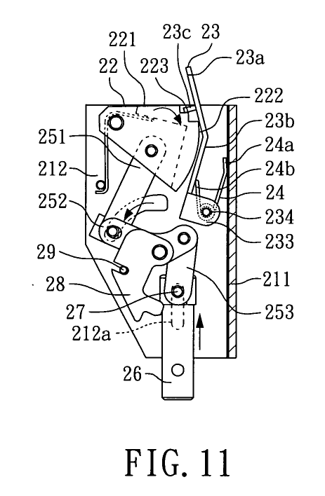

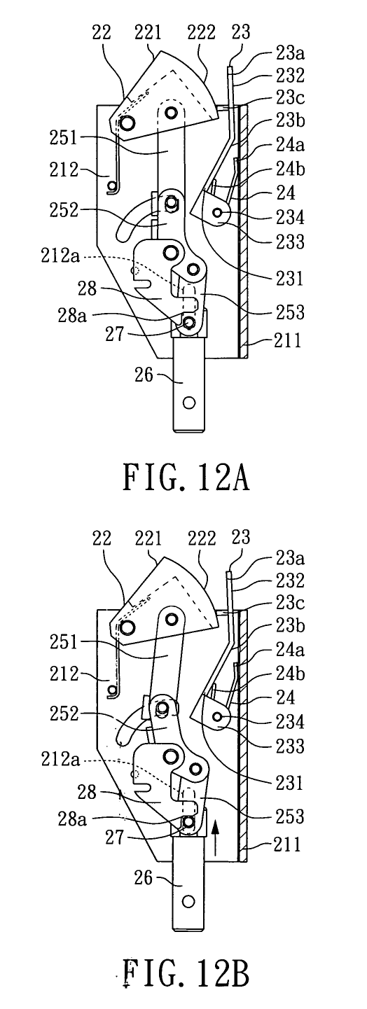

Operation of the latch assembly 20 of fire door lock in this embodiment similar to that of the first preferred embodiment will be described in detail below. With reference to FIG. 9 or 10, when the fire door is opened via the main lock body (not shown in the drawings) of fire door lock, the connection rod 26 is driven to move upward and meantime drives the lower rod 253 to move upward that makes the middle rod 252 rotate in counterclockwise to drive the upper rod 251 to pull the latch bolt 22 downward, so that the latch bolt 22 retracts into the latch base 21 to release latched state. In order to keep retaining unlatched state after opening the fire door, the resilient member 24 contacts against the stopper 23 to allow the blocked protrusion 23c of the stopper 23 to engage with the blocked surface 221 of the latch bolt 22 capable of limiting the latch bolt 22 within the latch base 21. Otherwise, with reference to FIGS. 8 and 11, the blocked protrusion 23c of the stopper 23 is capable of engaging with the step portion 223 of the latch bolt 22 in another embodiment. With reference again to FIG. 9 or 10, when the fire door is closed, the stopper 23 is pushed toward the bottom 211 of the latch base 21 and compresses the resilient member 24 that makes the blocked surface 221 of the latch bolt 22 depart from the limitation of the blocked protrusion 23c of the stopper 23. Meantime, the restoration spring 224 will push the latch bolt 22 to restore that the latch bolt 22 projects from the top 21a of the latch base 21 to back to latched state. In addition, operation of the self-locking member 28 and the hot-melt member 29 will be described in detail below by referring FIG. 12A-12B. First, with reference to FIGS. 7 and 12A, when fire is going for the fire door, temperature of latch assembly 20 will rise and when reaching the melting temperature, the hot-melt member 29 will melt. Meantime, the self-locking member 28 will rotate downward because the limitation of the hot-melt member 29 should no more exist and the limit end 28a of the self-locking member 28 is corresponding to the joint pin 27. With reference to FIGS. 7 and 12B, when the limit end 28a of the self-locking member 28 corresponds to the joint pin 27, the joint pin 27 is blocked by the limit end 28a of the self-locking member 28 and unable to move, the connection rod 26 is directly limited to be unmovable upward as well as the middle rod 252 is indirectly limited not to rotate in counterclockwise, so that the latch bolt 22 cannot retract into the latch base 21 to release latched state. Accordingly, fire ability of the latch assembly 20 of fire door lock is widely improved capable of preventing the fire door from being opened and blocking spread of fire.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A latch assembly of fire door lock comprising:
a latch base having a bottom;
a latch bolt retractably pivoted within the latch base and having a blocked surface;
a stopper swayingly pivoted within the latch base and having a blocked protrusion;
a resilient member disposed between the bottom of the latch base and the stopper and contacting against the stopper, the blocked protrusion of the stopper is capable of engaging with the blocked surface of the latch bolt; and
a linked unit disposed within the latch base and pivotally connected with the latch bolt.

2. The latch assembly of fire door lock in accordance with claim 1, wherein the stopper has a first surface and a second surface opposite to the first surface, the resilient member contacts against the second surface and the blocked protrusion projects from the first surface.

3. The latch assembly of fire door lock in accordance with claim 2, wherein the latch bolt further has an arc surface adjacent to the blocked surface and the blocked protrusion of the stopper is capable of pressing the arc surface of the latch bolt.

4. The latch assembly of fire door lock in accordance with claim 3, wherein the latch bolt further has a step portion formed at the blocked surface but adjacent to the arc surface, the blocked protrusion of the stopper is capable of engaging with the step portion.

5. The latch assembly of fire door lock in accordance with claim 2, wherein the stopper has a first end swayingly pivoted within the latch base and a second end opposite to the first end, the blocked protrusion is formed between the first end and the second end.

6. The latch assembly of fire door lock in accordance with claim 5, wherein the stopper has at least one fixing portion formed at the first end of the stopper.

7. The latch assembly of fire door lock in accordance with claim 6, wherein the stopper has two fixing portions and each of the fixing portions projects from the first surface of the stopper.

8. The latch assembly of fire door lock in accordance with claim 6, wherein the stopper has two fixing portions and each of the fixing portions projects from the second surface of the stopper.

9. The latch assembly of fire door lock in accordance with claim 5, further comprising a fixing pin installed penetrating the fixing portion of the stopper and fixed the fixing portion at the latch base.

10. The latch assembly of fire door lock in accordance with claim 2, wherein the resilient member has a support end contacting against the second surface of the stopper.

11. The latch assembly of fire door lock in accordance with claim 1, wherein the bottom of the latch base has a trench, one end of the resilient member is disposed at the trench of the bottom and another end contacts against the stopper.

12. The latch assembly of fire door lock in accordance with claim 1, wherein the resilient member has a contact end pressing at the bottom of the latch base.

13. The latch assembly of fire door lock in accordance with claim 1, wherein the resilient member has a contact end capable of fixing at the bottom of the latch base.

14. The latch assembly of fire door lock in accordance with claim 1, wherein the latch base further has a first lateral, a second lateral opposite to the first lateral and a space formed among the first lateral, the second lateral and the bottom.

15. The latch assembly of fire door lock in accordance with claim 14, wherein the first and second laterals have a bias runner formed thereon respectively, the bias runners are corresponding to each other and communicate with the space.

16. The latch assembly of fire door lock in accordance with claim 15, further comprising at least one self-locking member that is disposed into the bias runners of the first lateral and the second lateral.

17. The latch assembly of fire door lock in accordance with claim 16, further comprising a pair of hot-melt members that are fixed at each of the bias runners of the first and second laterals respectively and block the self-locking member.

18. The latch assembly of fire door lock in accordance with claim 16, further comprising a hot-melt member which is inserted into and fixed at each of the bias runners of the first and second laterals and blocks the self-locking member.

19. The latch assembly of fire door lock in accordance with claim 16, wherein each of the bias runners has a position hole, the self-locking member is capable of sliding into each of the position holes and blocking the linked unit.

20. The latch assembly of fire door lock in accordance with claim 19, wherein the linked unit at least comprises a middle rod, the self-locking member is capable of blocking the middle rod of the linked unit.

21. The latch assembly of fire door lock in accordance with claim 14, further comprising at least one self-locking member, the linked unit at least comprising a middle rod and a lower rod, the self-locking member is pivotally disposed at one side of the middle rod.

22. The latch assembly of fire door lock in accordance with claim 21, wherein further comprising a hot-melt member that is inserted into and fixed at the latch base, the self-locking member has a limit end contacting against the hot-melt member.

23. The latch assembly of fire door lock in accordance with claim 21, wherein the first and second laterals have a longitudinal runner formed thereon respectively, the longitudinal runners are corresponding to each other and communicate with the space.

24. The latch assembly of fire door lock in accordance with claim 23, further comprising a joint pin slideably disposed into the longitudinal runners of the first and second laterals and a connection rod, the joint pin connects the lower rod of the linked unit and the connection rod.

25. The latch assembly of fire door lock in accordance with claim 24, wherein the self-locking member is capable of blocking the joint pin.

26. The latch assembly of fire door lock in accordance with claim 25, wherein the self-locking member has a limit end capable of blocking the joint pin.

27. The latch assembly of fire door lock in accordance with claim 1, further comprising a restoration spring which is pivotally disposed at one end of the latch bolt and one end of the restoration spring contacts against the latch bolt.
